(19) United States
(12) Patent Application Publication
(10) Pub. No.: US 2009/0110553 A1
(43) Pub. Date: Apr. 30, 2009

(54) Omnidirectional electric fan and fan blade structure

(76) Inventor: Min-I Wu, Bali Shiang (TW)

Correspondence Address: Frenkel & Associates, P.C.;Suite 330, 3975 University Drive,, Fairfax, VA, 22030, US

(21) Appl. No.: 11/978,448

(22) Filed: Oct. 30, 2007

(51) Int. Cl. F04D 19/00; F03B 3/12

(52) U.S. Cl. 415/211.1; 416/235

(57) ABSTRACT

The present invention discloses an omnidirectional electric fan and a fan blade structure. The fan blade structure comprises: a transmission shaft, a lower connection element, an upper connection element and a plurality of fan blades. The fan blades are radiately secured in between said lower connection element and said upper connection element. Each fan blade has a root portion and a wing portion. The wing portion extends from the edge of the root portion toward both sides to form a wider portion at the border of the fan blade. The fan blade structure cooperates with a seat, a cover, a plurality of fan grills and a dynamic source to from an omnidirectional electric fan.

### FIELD OF THE INVENTION

The present invention relates to an omnidirectional electric fan and a fan blade structure, wherein the active areas of the fan blade are designed to create a first pressure zone and a second pressure zone, and whereby the fan blade structure can realize an omnidirectional electric fan.

### BACKGROUND OF THE INVENTION

Rotating fan blades to generate airflow is a long-standing technology, which is mostly used in cooling or air circulation. A Taiwan patent No.M302003 disclosed a “Structure of Fan Blade Assembly for Exhaust/Suction Blower”, wherein the tilt angle of fan blades is adjusted to vary the intensity of airflow. A Taiwan patent No.M300731 disclosed a “Fan Blade Structure for External Rotor Motor”, wherein counter weights are added to fan blades. A Taiwan patent No.M300427 disclosed a “Multi-Layer Fan Blade Structure”, wherein several sets of fan blades are arranged on a hub, and a fixed ring is interposed in between each two sets of fan blades. All the abovementioned fan blades are hard to provide wide-range airflow but can only generate unidirectional airflow. One conventional solution is to arrange several electric fans at different angles or in different positions. However, such a solution increases cost and wastes space. Another solution is to rotate an electric fan to increase the effective range thereof. Such a solution is often seen in daily living. For example, a Taiwan patent No.M298654 discloses a “360-Degree Rotation Stand Fan”, wherein a secondary motor is used to drive a motor having a fan blade structure to rotate and convert a unidirectional electric fan into a 360-degree rotation electric fan. However, such a technology also increases considerable cost and has an overweight problem. Besides, airflow is not really multidirectional at the same time. From the above discussion, it is known that most of the conventional electric fans generate only unidirectional airflow. Therefore, there is still room to improve conventional electric fans to achieve omnidirectional airflow.

### SUMMARY OF THE INVENTION

The primary objective of the present invention s to provide an fan blade structure, which can generate a 360-degree air flow and outperform the conventional technology that is hard to provide airflows by 360 degrees at the same time.

The present invention proposes an omnidirectional electric fan and a fan blade structure. The fan blade structure is coupled to a dynamic source to obtain the dynamic power for rotation. The rotation of the fan blade structure generates pressure drop and then induces airflow. The fan blade structure comprises: a transmission shaft, a lower connection element arranged on the transmission shaft, an upper connection element also arranged on the transmission shaft, and a plurality of fan blades radiately secured in between the lower connection element and the upper connection element. Each fan blade has a root portion, a wing portion, and a press-fit portion. The wing portion extends from the edge of the root portion toward both sides to form a wider portion at the border of the fan blade. When the fan blades are driven to rotate, a first pressure zone is formed above the fan blade structure, and a second pressure zone is formed in the perimeter of the wing portion. The pressure drop between the first and second pressure zones induces airflow. As the plurality of fan blades is radiately arranged around the transmission shaft, the rotation of the fan blades can generate 360-degree airflows around the transmission shaft. The omnidirectional electric fan of the present invention comprises: a seat, a dynamic source, a plurality of fan grills, a cover, and the abovementioned fan blade structure. The seat and the cover respectively have lower ventilation holes and upper ventilation holes. The fan grills are network structures allowing air to pass. Thereby, the assembly of the seat, cover and fan grills is a structure allowing airflows to enter from the top and bottom and to leave from the lateral side. The dynamic source is arranged inside the seat. The seat has a control panel to control the operation of the dynamic source. Thus is realized an omnidirectional electric fan having 360-degree airflows.

### BRIEF DESCRIPTION OF THE DRAWINGS

FIG. 1 is a perspective view schematically showing one embodiment of the present invention.

FIG. 2 is an exploded view schematically showing one embodiment of the present invention.

FIG. 3 is an exploded view schematically showing a fan blade structure according to the present invention.

FIG. 4 is an enlarged view schematically showing a fan blade according to the present invention.

FIG. 5 is a top view schematically showing a fan blade structure according to the present invention.

FIG. 6 is a diagram schematically showing the operation of one embodiment of the present invention.

FIG. 7 is an exploded view schematically showing another embodiment of the present invention.

### DETAILED DESCRIPTION OF THE PREFERRED EMBODIMENTS

The technical contents of the present invention will be described in detail in cooperation with the drawings below.

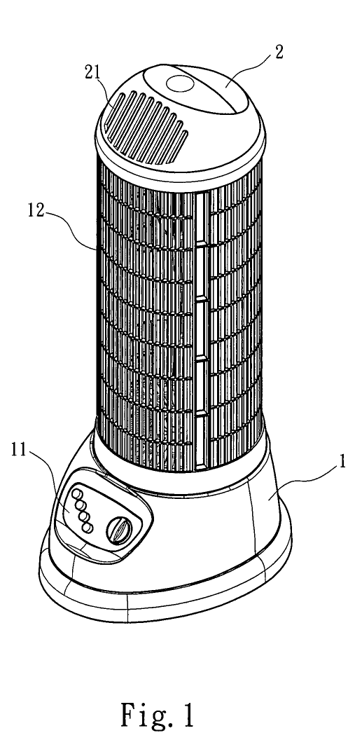

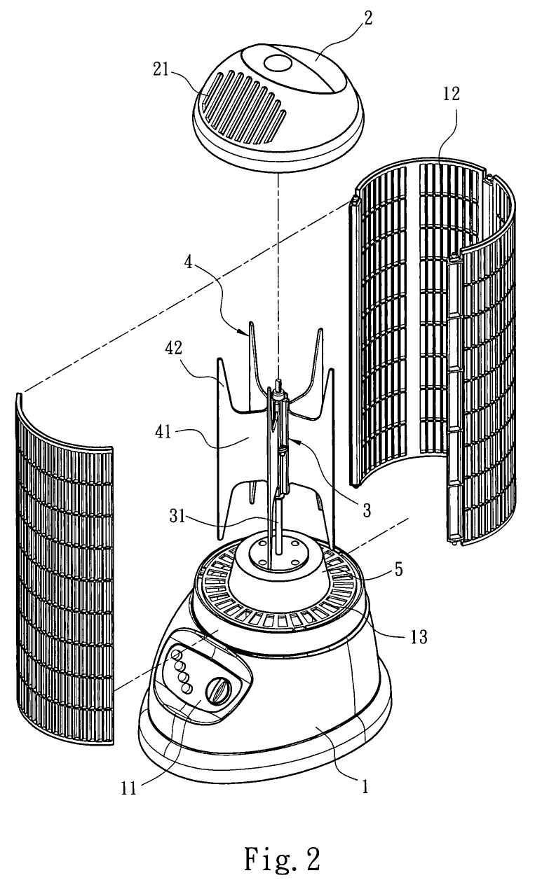

The fan blade structure of the present invention is installed in an omnidirectional electric fan and powered by the omnidirectional electric fan to rotate and form pressure drop to generate airflow. Refer to FIG. 1 and FIG. 2 respectively a perspective view and an exploded view schematically showing one embodiment of the present invention. The omnidirectional electric fan of the present invention comprises: a seat 1, a plurality of fan grills 12, a dynamic source 5, a cover 2 and a fan blade structure having a central pole 3 and a plurality of fan blades 4. The central pole 3 is coupled to the dynamic source 5 through a transmission shaft 31. The dynamic source 5 is fixedly installed in an accommodation room of the seat 1. The surface of the seat 1 has a control panel 11 used to control the operation of the dynamic source 5. The seat 1 has a plurality of lower ventilation holes 13 allowing airflow to pass. The seat 1 has a space allowing the airflow to circulate and pass the lower ventilation holes 13. The fan grill 12 is a network allowing airflow to pass. The fan grills 12 are joined to each other and snap-fitted to the border of the top of the seat 1. The upper edges of the fan grills 12 are secured with the cover 2. The cover 2 has a plurality of upper ventilation holes 21 allowing airflow to pass. Thus is constructed the omnidirectional electric fan of the present invention.

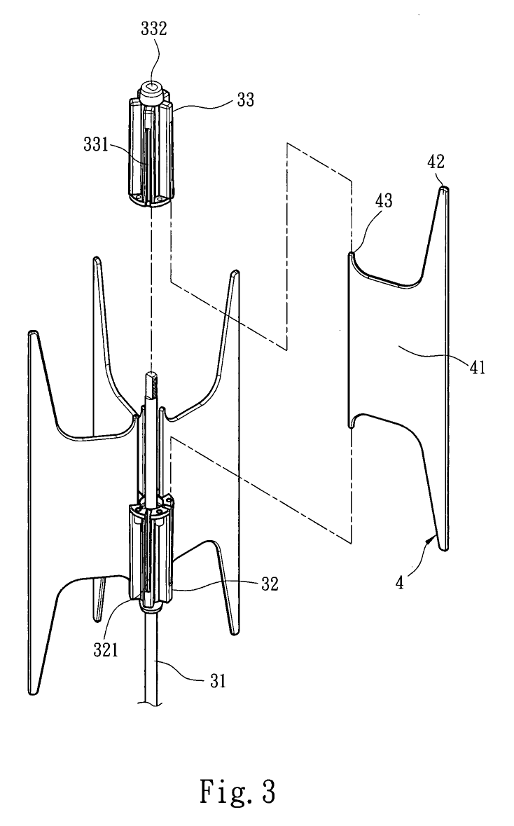

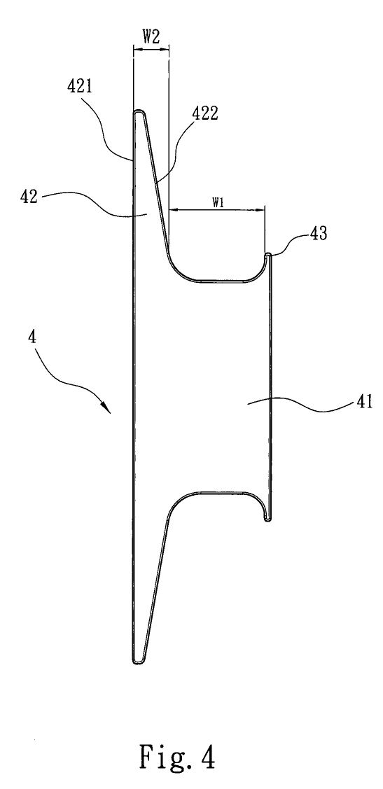

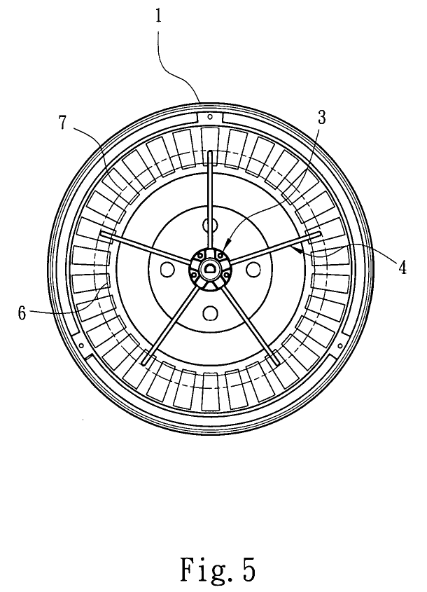

Refer to FIG. 3 an exploded view schematically showing the fan blade structure according to the present invention. The fan blade structure includes the central pole 3 and the fan blades 4. The central pole 3 further includes: a transmission shaft 31, a lower connection element 32 and an upper connection element 33. The upper connection element 33 has a positioning hole 332 to be passed through by the transmission shaft 31. The cross section of the transmission shaft 31 is the same as that of the positioning hole 332. The positioning hole 332 has at least one positioning plane, which closely matches the corresponding positioning plane of the transmission shaft 31. Via the transmission shaft 31, the dynamic source 5 drives the fan blades 4 to rotate. The fan blade 4 further includes: a press-fit portion 43, a root portion 41 and a wing portion 42 extending up and down from the root portion 41. The width of the wing portion 42 is much greater than that of the root portion 41, and the fan blade 4 thus has a wider edge. The press-fit portion 43 of the fan blade 4 is engaged with the lower connection element 32 and the upper connection element 33. The lower connection element 32 is installed on the transmission shaft 31 and has a plurality of lower connection slots 321 to be press-fitted into by the fan blades 4. The upper connection element 33 slides from top downward to grip the fan blades 4. The press-fit portion 43 of the fan blade 4 presses against the walls of the lower connection slot 321 and upper connection slot 331. Thereby, the fan blades 4 are secured. The fan blades 4 are radiately joined to the transmission shaft 31. Refer to FIG. 4 and FIG. 5 respectively an enlarged view for a single fan blade and a top view for the assembly of the fan blades. The length W1 between the press-fit portion 43 and wing portion 42 is greater than the length W2 between the inner edge and outer edge of the wing portion 42. The width between two tips of the wing portion 42 is greater than the width between two sides of the root portion 41. When the fan blade structure rotates, the outer edge 421 of the wing portion 42 and the front edge of the root portion 41 apply force to air, which creates a second pressure zone 7. The second pressure zone 7 generates airflow and creates a lower pressure between the inner edge 422 of the wing portion 42 and the side edge of the root portion 41. Then, a first pressure zone 6 is formed above the transmission shaft 31. The pressure of the first pressure zone 6 is lower than that of the second pressure zone 7. Thus, airflows are sucked into the omnidirectional electric fan from above and below and sent out from the outer edge 421 of the wing portion 42 and the front edge of the root portion 41.

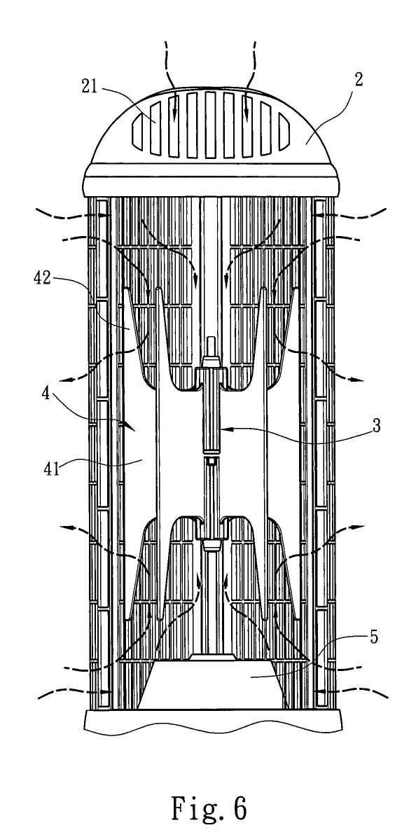

Refer to FIG. 6 a diagram schematically showing the operation of the present invention. When the dynamic source 5 drives the transmission shaft 31 and fan blades 4 to rotate, the second pressure zone 7, which is generated by the outer edge 421 of the wing portion 42 and the front edge of the root portion 41, and the first pressure zone 6, which is above the transmission shaft 31, create airflows flowing toward both sides. The upper and lower first pressure zones 6 suck air to respectively flow through the upper ventilation holes 21 of the cover 2 and the lower ventilation holes 13 (not shown in the drawing) of the seat 1 and thus generate a great amount of airflow. The fan blades 4 are radiately arranged around the transmission shaft 31. Therefore, the rotation of the fan blades 4 can generates airflow by 360 degrees. Thus, an omnidirectional electric fan is realized.

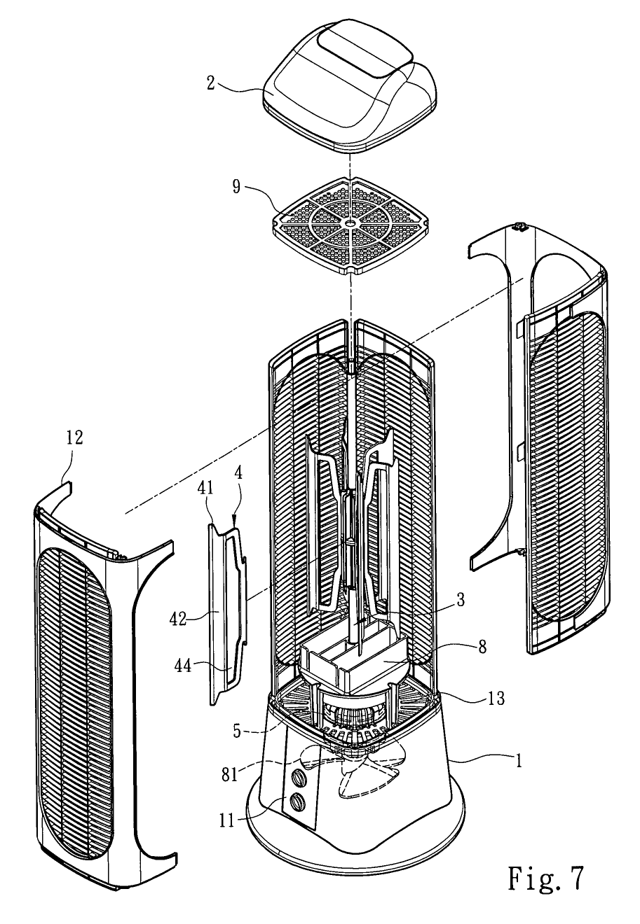

The appearance design of the present invention is not limited to a cylindrical structure. Refer to FIG. 7 for another embodiment of the present invention. The seat 1, the cover 2 and the fan grills 12 are assembled to form a rectangular structure. To increase airflow, the root portion 41 of the fan blade 4 may be carved to have a guide hole 44 thereon, and the outer edge of the guide hole 44 is greater than the inner edge. Besides, a heater 8 may be arranged below the fan blades 4, and an electric fan may be arranged inside the seat 1. After the heater 8 is started from the control panel 11, the electric fan 81 is also started to send airflow through the lower ventilation holes 13 and the heater 8. Then, warm air is further distributed omnidirectionally. Additionally, an air purification member 9 may be arranged inside the omnidirectional electric fan, and the air purification member 9 may be an air filter, such as an activated-charcoal filter.

Those preferred embodiments described above are only to exemplify the present invention but not to limit the scope of the present invention. Any equivalent modification or variation made by a person skilled in the art according to the spirit of the present invention is to be also included within the scope of the present invention, which is based on the claims stated below.

In conclusion, the advantages of the present invention over the conventional technology have been shown above, and it proves that the present invention indeed has novelty and non-obviousness and meets the conditions for a patent. Thus, the Inventor files a patent application for the present invention. It will be appreciated that the patent is approved fast.

What is claimed is:

1. A fan blade structure, which is used in an omnidirectional electric fan and driven by a dynamic source of said omnidirectional electric fan to rotate and create pressure drop to generate airflow, characterized in comprising:
a transmission shaft coupled to said dynamic source and cooperating with a lower connection element and an upper connection element to form a central pole; and
a plurality of fan blades each having a root portion, a wing portion and a press-fit portion, wherein said fan blades are radiately secured from said press-fit portion and in between said lower connection element and said upper connection element, and wherein said wing portion extends from the edge of said root portion toward both sides to form a wider portion at the border of said fan blade, and wherein when said transmission shaft drives said fan blades to rotate, a first pressure zone is formed over said fan blades, and a second pressure zone is formed in between the outer edge of said wing portion and the front edge of said root portion, and the pressure drop between said first pressure zone and said second pressure zone induces airflow.

2. The fan blade structure according to claim 1, wherein the width between both sides of said root portion is smaller than the width of both tips of said wing portion.

3. The fan blade structure according to claim 1, wherein the length from said press-fit portion to said wing portion is greater than the length from the inner edge of said wing portion to the outer edge of said wing portion.

4. The fan blade structure according to claim 1, wherein the rotation of said fan blade structure applies force to air and forms said second pressure zone at the front edge of said wing portion.

5. The fan blade structure according to claim 4, wherein said first pressure zone is formed in between the inner edge of said wing portion and said lateral sides of said root portion during the rotation of said fan blade structure; said first pressure zone is a relatively lower pressure zone in comparison with said second pressure zone.

6. The fan blade structure according to claim 1, wherein said lower connection element and said upper connection element respectively have lower connection slots and upper connection slots, and said press-fit portions of said fan blades are press-fitted into said lower connection slots and said upper connection slots.

7. The fan blade structure according to claim 1, wherein said upper connection element has a positioning hole to be passed through by said transmission shaft, and said transmission shaft has at least one positioning plane, which closely matches the corresponding positioning plane of said positioning hole.

8. The fan blade structure according to claim 1, wherein said fan blade is carved to have a guide hole thereon.

9. The fan blade structure according to claim 8, wherein the outer-edge dimension of said guide hole is greater than the inner-edge dimension of said guide hole.

10. An omnidirectional electric fan comprising:
a seat having a control panel thereon, a plurality of lower ventilation holes thereon, and an accommodation space thereinside;
a dynamic source arranged inside said accommodation space of said seat;
a plurality of fan grills joined to the top of said seat;
a cover joined to the top of said fan grills;
a fan blade structure further comprising a transmission shaft, a lower connection element, an upper connection element, and a plurality of fan blades, wherein said fan blade includes: a root portion, a wing portion and a press-fit portion, and wherein said fan blades are radiately secured from said press-fit portion and in between said lower connection element and said upper connection element, and wherein said wing portion extends from the edge of said root portion toward both sides to form a wider portion at the border of said fan blade, and wherein said transmission shaft is coupled to said dynamic source and drives said fan blade structure to rotate, and wherein during the rotation of said fan blades, a first pressure zone is formed over said fan blades, and a second pressure zone is formed in between the outer edge of said wing portion and the front edge of said root portion, and wherein the pressure drop between said first pressure zone and said second pressure zone induces airflow to realize said omnidirectional electric fan.

11. The omnidirectional electric fan according to claim 10, wherein said seat is hollow and allows airflow to circulate, pass said lower ventilation holes and run toward said fan blade structure.

12. The omnidirectional electric fan according to claim 10, wherein said cover has a plurality of upper ventilation holes.

13. The omnidirectional electric fan according to claim 10, wherein the width between both sides of said root portion is smaller than the width of both tips of said wing portion.

14. The omnidirectional electric fan according to claim 10, wherein the length from said press-fit portion to said wing portion is greater than the length from the inner edge of said wing portion to the outer edge of said wing portion.

15. The omnidirectional electric fan according to claim 10, wherein the assembly of said seat, said cover and said fan grills has a rectangular-column shape.

16. The omnidirectional electric fan according to claim 10, wherein the assembly of said seat, said cover and said fan grills has a cylindrical shape.

17. The omnidirectional electric fan according to claim 10 further comprising: a heater arranged beside said lower ventilation holes, and an electric fan arranged below said heater.

18. The omnidirectional electric fan according to claim 10, wherein said fan blade is carved to have a guide hole thereon.

19. The omnidirectional electric fan according to claim 18, wherein the outer edge of said guide hole is greater than the inner edge of said guide hole.

20. The omnidirectional electric fan according to claim 10, wherein an air purification member is connected to the inner rim of said fan grills.
